(19) United States
(12) Patent Application Publication
(10) Pub. No.: US 2010/0139789 A1
(43) Pub. Date: Jun. 10, 2010

(54) RELIEF VALVE WITH FLUID OUTLET

(76) Inventor: Lawrence M. Dulac, Deerfield, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/328,086

(22) Filed: Dec. 4, 2008

(51) Int. Cl. F16K 15/00

(52) U.S. Cl. 137/535

(57) ABSTRACT

A relief valve comprises a housing having a supply line inlet, for allowing fluid to enter the housing and a fluid supply outlet configured for allowing fluid to exit the housing. The fluid exiting the housing flows proximate and against a valve seat, thereby, flushing the valve seat. The relief valve also includes a relief outlet having an inlet region and an outlet region and a valve mechanism. The valve mechanism includes a valve seat configured for operation between a first, closed position closing the inlet region of the relief outlet inlet region thereby preventing fluid from exiting the relief outlet, and a second, open position opening the inlet region of the relief outlet inlet region, thereby allowing fluid to exit from the housing through the relief outlet.

### TECHNICAL FIELD

The present invention relates to pressure valves and more particularly, relates to a relief valve having a constant flow of fluid for cleaning the internal aspect of the valve.

### BACKGROUND INFORMATION

Residential and commercial water heaters and boilers typically include a pressurized tank or vessel where heated water is stored until it is required for use. The temperature and pressure of the water being stored will typically vary within a predetermine limit as the water heater operates normally. When there is a malfunction, the temperature and/or pressure of the water stored within even a common residential water heater will rise, sometimes significantly, and can inflect severe injury and damage, even death. For example, if the tank fails due to excessive pressure in the water supply, boiling of the water, or age, extremely hot water may spread explosively from the tank over a considerable distance.

In order to prevent these catastrophic results, residential and commercial water heaters and boilers include a relief valve that releases water/steam when the temperature and/or pressure of the water in the tank exceeds a predetermined value. The discharge side of the relief valve is typically connected to a discharge pipe, which releases the pressurized hot water into a reservoir or along the floor where there is less danger of injury to individuals.

While there are a variety of known relief valves used with water heaters and boilers, they may develop slow leaks or the valve internal workings or “seat” may become clogged with an accumulation or build-up of water born minerals or the like. The build-up restricts the ability of the valve to function properly and efficiently without any hindrance. Therefore, there is a critical need for a valve that can constantly clean and flush the valve seat to remove the particles that buildup near the valve seat. This build up is becoming even more prevalent now that hot water tanks are being manufactured with more and thicker insulation. Thus, the valve “stems” that are inserted into a hot water tank are longer facilitating more mineral deposits due to colder temperature of the valve seat and a larger volume or hot air bearing deposits.

In addition, many systems do not utilize reservoirs or drains and users will often permanently plug the outlet of the relief valve to avoid water from dripping onto the floor. The act of permanently plugging a relief valve is commonplace and has resulted in many injuries and deaths due to the inability of the plugged relief valve from performing as it was intended.

Therefore, it would be desirable to have a fluid discharge system that would allow reduction of the possibility of blockage or clogging of a valve while still allowing the valve to properly function if the tank or boiler becomes unsafe.

### SUMMARY

The present invention is a relief valve comprising a housing that has a supply line inlet for allowing fluid to enter the housing. The housing also includes a relief outlet in fluid communication with the housing and having an inlet region and an outlet region. Within the housing, there is a valve mechanism, disposed between the supply line inlet and the inlet region of the relief outlet. The valve mechanism includes a valve seat in fluid communication with the housing, and configured for operation between a first, closed position closing the inlet region of the relief outlet thereby preventing fluid from exiting the relief outlet, and a second, open position opening the inlet region of the relief outlet, thereby allowing fluid to exit from the housing through the relief outlet.

The valve housing also includes a fluid supply outlet, in fluid communication with the housing, and configured for allowing fluid to exit the housing. The fluid supply outlet also causes the fluid flow exiting the housing to flow proximate and against the valve seat, for flushing the valve seat.

### BRIEF DESCRIPTION OF THE DRAWINGS

These and other features and advantages of the present invention will be better understood by reading the following detailed description, taken together with the drawings wherein:

FIG. 1 is a perspective view of one embodiment of the relief valve with a fluid outlet.

### DETAILED DESCRIPTION OF THE PREFERRED EMBODIMENTS

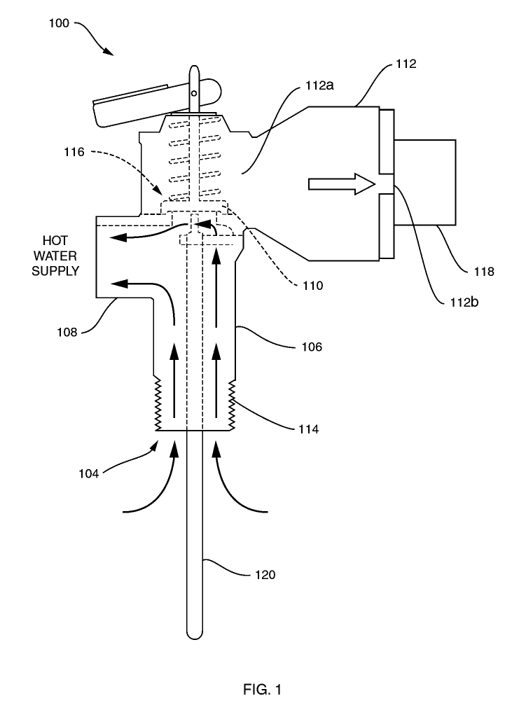

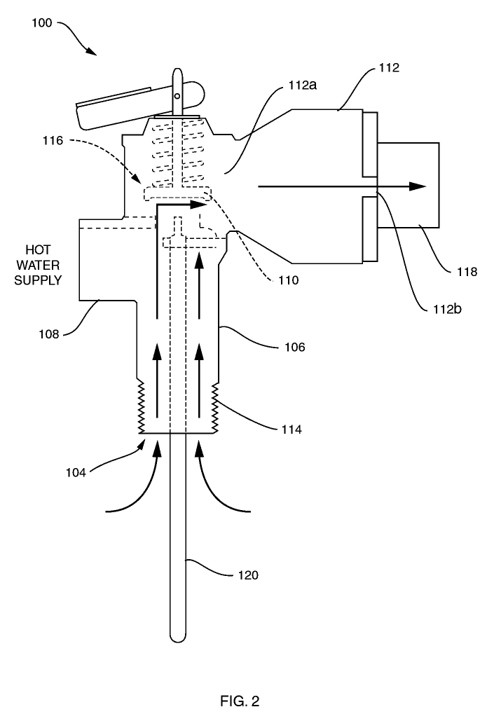

The relief valve 100 in one embodiment, FIG. 1, includes a housing or body 100 that includes a supply line inlet 104. This supply line inlet 104 introduces fluid into the relief valve. The supply line inlet 104 typically includes an externally threaded region 114 configured for threadably interconnecting with a water heater tank, for supplying hot water from the tank to the valve housing. The supply line inlet 104 may be connected to a fluid source using various connection mechanisms such as externally and internally threaded regions and the like.

Fluid entering the inlet 104 continues to flow along a supply line 106 and then exits the valve 100 at a fluid supply outlet 108. The supply line outlet 108 may include a connection mechanism for engaging/connecting with an adaptor such as, by way of example only, an externally or internally threaded region. The supply line 106 and outlet 108 are configured for allowing and in fact causing fluid entering and exiting the valve to flow proximate, around and/or against a valve seat 110 of the valve. By allowing fluid to flow past, around and/or againt the seat of the valve, the seat is flushed or cleansed of any deposits or materials that have built-up on or around the seat's and its surfaces. This cleansing or flushing action prevents any buildup of materials within the interior of the valve which might otherwise prevent the valve from properly functioning in an emergency situation.

The housing of the relief valve also has a relief outlet 110 that is in fluid communication with the supply line 106. The relief outlet 110 has an inlet region 112a and outlet region 112b. The outlet region 112b of the relief outlet opens to the atmosphere.

The valve mechanism 116 is disposed in the housing between the supply line inlet 104 and the inlet region 112a of the relief outlet. The relief valve 100 may include a temperature relief valve mechanism 116 where the valve mechanism 116 is operative to move from a first position to a second position upon detecting a certain temperature of the fluid within the valve housing or within the holding tank into which the relief valve is inserted. The temperature relief mechanism may also include a thermal sensing element 120 that is preferably disposed in the supply line and/or extends beyond the supply line inlet into the tank.

The valve mechanism 116 includes a valve seat 110 configured for operation between a first, closed position and a second, open position. In the closed position, the inlet region 112a is blocked thereby preventing fluid from exiting through the relief outlet 112 allowing fluid to exit the valve 100 by means of outlet 108. In the open position, the inlet region 112a is opened up so that fluid can exit from the housing through the relief outlet 112b to relieve excess pressure. The pressure relief outlet 112b section may be connected to a discharge pipe or the like 118 using various connection mechanisms such as externally and internally threaded regions, soldering and the like. In another embodiment, the valve relief outlet 112b may be connected to or may include a built in device to prevent the valve 100 from being blocked and that can disengage from the relief valve at a predetermined pressure allowing the relief valve to function as intended such as disclosed in U.S. Pat. No. 6,698,714 by the present inventor and incorporated herein fully be reference. Modifications and substitutions by one of ordinary skill in the art are considered to be within the scope of the present invention, which is not to be limited except by the allowed claims and their legal equivalents.

The invention claimed is:

1. A relief valve comprising:
a housing, the housing comprising:
a supply line inlet, for allowing fluid to enter the housing;
a relief outlet, in fluid communication with said housing and having an inlet region and an outlet region;
a valve mechanism, disposed in said housing between said supply line inlet and said inlet region of said relief outlet and including a valve seat in fluid communication with said housing, and configured for operation between a first, closed position closing said inlet region of said relief outlet inlet region thereby preventing fluid from exiting said relief outlet, and a second, open position opening said inlet region of said relief outlet inlet region, thereby allowing fluid to exit from said housing through said relief outlet; and
a fluid supply outlet, in fluid communication with said housing, and configured for allowing fluid to exit said housing when said valve seat is in said closed position and for causing a fluid flow exiting said housing to flow proximate and against said valve seat, for flushing debris from said valve seat.

2. The relief valve of claim 1, wherein said outlet region of the relief outlet opens to the atmosphere.

3. The relief valve of claim 1, wherein said valve mechanism is a temperature relief valve mechanism, and wherein said temperature relief valve mechanism is operative to move from said first position to said second position upon detecting a predetermined temperature in said fluid in said housing.

4. The relief valve of claim 1, wherein said valve mechanism is a temperature relief valve mechanism, and wherein said temperature relief valve mechanism is operative to move from said first position to said second position upon detecting a predetermined temperature in a fluid holding tank into which said relief valve is inserted.

5. The pressure relief valve of claim 1 wherein the supply line inlet is connected to a water heater tank for supplying hot water from a tank to the housing.

6. The pressure relief valve of claim 1 wherein the supply line inlet further comprises an externally threaded region for engaging with an internally threaded region of a source of fluid.

7. The pressure relief valve of claim 1 wherein the supply line outlet further comprises an internally threaded region for engaging with an externally threaded region of an adaptor.

8. The pressure relief valve of claim 1 further comprising a thermal sensing element disposed along the supply line inlet and extending beyond the supply line inlet into the atmosphere.

9. The pressure relief valve of claim 1 wherein the pressure relief outlet section further comprises an internally threaded region for engaging with an externally threaded region of an adaptor.

10. The pressure relief valve of claim 1 further comprising:
a bushing, coupled to said relief outlet region and configured to disengage from the relief valve outlet at a predetermined pressure allowing the relief valve to function as intended.

11. A relief valve comprising:
a housing, the housing comprising:
a supply line inlet, for allowing fluid to enter the housing;
a relief outlet, in fluid communication with said housing and having an inlet region and an outlet region;
a valve mechanism, disposed in said housing between said supply line inlet and said inlet region of said valve mechanism, and including a valve seat in fluid communication with said housing, and configured for operation between a first, closed position closing said inlet region of said relief outlet inlet region thereby preventing fluid from exiting said relief outlet, and a second, open position opening said inlet region of said relief outlet inlet region, thereby allowing fluid to exit from said housing through said relief outlet;
a fluid supply outlet, in fluid communication with said housing, and configured for allowing fluid to exit said housing when said valve seat is in said closed position and for causing a fluid flow exiting said housing to flow proximate and against said valve seat, for flushing said valve seat; and
a bushing, coupled to said relief outlet region and configured to disengage from the relief valve outlet at a predetermined pressure allowing the relief valve to function as intended.

12. The relief valve of claim 11, wherein said outlet region of the relief outlet opens to the atmosphere.

13. The relief valve of claim 11, wherein said valve mechanism is a temperature relief valve mechanism, and wherein said temperature relief valve mechanism is operative to move from said first position to said second position upon detecting a predetermined temperature in said fluid in said housing.

14. The relief valve of claim 11, wherein said valve mechanism is a temperature relief valve mechanism, and wherein said temperature relief valve mechanism is operative to move from said first position to said second position upon detecting a predetermined temperature in a fluid holding tank into which said relief valve is inserted.

15. The pressure relief valve of claim 1 wherein the supply line inlet is connected to a water heater tank for supplying hot water from a tank to the housing.

16. The pressure relief valve of claim 11 wherein the supply line inlet further comprises an externally threaded region for engaging with an internally threaded region of a source of fluid.

17. The pressure relief valve of claim 1 wherein the supply line outlet further comprises an internally threaded region for engaging with an externally threaded region of an adaptor.

18. The pressure relief valve of claim 1 further comprising a thermal sensing element disposed along the supply line inlet and extending beyond the supply line inlet into the atmosphere.

19. The pressure relief valve of claim 1 wherein the pressure relief outlet section further comprises an internally threaded region for engaging with an externally threaded region of an adaptor.
